(19) United States
(12) Patent Application Publication
(10) Pub. No.: US 2007/0111732 A1
(43) Pub. Date: May 17, 2007

(54) Method for determining a routing in an ad-hoc radio communications system

(75) Inventors: Hui Li, Beijing (CN); Dan Yu, Beijing (CN)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 10/577,663

(22) PCT Filed: Oct. 20, 2004
(86) PCT No.: PCT/EP04/52581

§ 371 Date: May 1, 2006

(30) Foreign Application Priority Data
Oct. 31, 2003 (DE) 103 50 906.2

(51) Int. Cl. H04Q 7/20

(52) U.S. Cl. 455/445

(57) ABSTRACT

A method determines a routing for radio transmission between a first and a second radio station of a radio communication system, said system having a plurality of additional radio stations in addition to the first and the second radio stations. The routing passes through at least two of the additional radio stations, in such a way that information can be transmitted by radio between the first and the second radio stations via the routing. The system is provided with a radio communication device, which recognizes adjacent relationships between the radio stations of the radio communications systems. The radio communication device specifies a sub-group of the radio stations in the routing in response to a request for the determination of a routing between the first and the second radio stations and transmits respective radio stations identification information relating to one ore more radio stations in the sub-group of radio stations to the first and/or second radio station(s).

The invention relates to a method for determining a routing for radio transmission between two radio stations of a radio communications system. Furthermore the invention relates to a radio device for a radio communications system for executing the method.

In radio communications systems information (for example speech, picture information, video information, SMS (Short Message Service) or other data) is transmitted with the aid of electromagnetic waves via a radio interface between sending and receiving station. The stations can in this case, depending on the actual embodiment of the radio communications system, be various types of subscriber-side radio stations, radio access points or base stations. The electromagnetic waves in such systems are radiated using carrier frequencies which lie within the frequency range provided for the relevant system.

Radio communications systems are often embodied as cellular systems, e.g. in accordance with the GSM (Global System for Mobile Communication) or UMTS (Universal Mobile Telecommunications system) standard, with a network infrastructure consisting for example of base stations, devices for checking and control of the base stations and further network-side devices. Frequencies at 900, 1800 and 1900 MHz are used for the cellular GSM mobile radio system. The cellular mobile radio communications systems essentially transmit speech, facsimile and short messages.

As well as these cellular, hierarchical radio networks organized on a wide-area (supralocal) basis, there are also Wireless Local Area Networks (WLANs) with a radio coverage that as a rule is far more limited. The cells covered by the radio access points (AP) of the WLANs, with a radius of up to a few hundred meters, are small by comparison with usual mobile radio cells. Examples of different standards for WLANs are HiperLAN, DECT, IEEE 802.11, Bluetooth and WATM. However, particularly in the USA and Europe, these local radio networks which are coming to the fore appear to be almost exclusively products based on the IEEE 802.11 family.

Generally the non-licensed frequency range around 2.4 GHz is used for WLANs. Data transmission rates lie in the range up to 11 Mbit/s. Future WLANs can be operated in the 5 GHz range and achieve data rates of over 50 Mbit/s. This provides subscribers of the WLANs with data rates which are significantly higher than those offered by the third mobile radio generation (such as UMTS for example). This means that for the transmission of large volumes of data, especially in connection with Internet accesses, access to WLANs for high bit rate connections is advantageous.

A connection to other communication systems, for example to broadband data networks (BDN Broadband Data Networks) can thus be made via the WLAN radio access points. To this end the radio stations of the WLAN communicate either directly with the radio access point or with more remote radio stations via other radio stations which forward the information between the radio station and the radio access point.

In an ad-hoc mode of a radio communications system radio stations can communicate with each other via one or more hops (hop, multihop) without the intermediate connection of switching devices such as base stations or radio access points for example. If a radio station intends to transmit data to another radio station in an ad-hoc mode, a routing must first be determined between the radio station and the recipient of the data. A routing passes via one or more radio stations which forward information for a data transmission between transmitter and receiver. The radio stations of the routing are thus directly adjacent radio stations which can communicate with each other directly via radio.

A routing can be determined locally by different methods by the radio stations of the ad-hoc system. Depending on the methodology used to determine the routing, a plurality of signaling messages are sent in this case, so that a significant strain can be imposed on the scarce radio communication resources through the determination of the routing. As an alternative to this the routing can also be determined by a central device which knows about the adjacent relationships between the radio stations of the ad-hoc network. Depending on the size of the ad-hoc system, this involves a great deal of computing effort on the part of the central device.

The object of the invention is to demonstrate an efficient method for determining a routing between two radio stations of a radio communications system. This is especially designed to take account of the fact that a radio device with information about the topology of the network of the radio stations is available. Furthermore such a radio device for executing the method is to be presented.

This object is achieved, as regards the method, by a method with the features of claim 1.

Advantageous embodiments and further developments are the object of the subclaims.

The method is used to determine a routing for radio transmission between a first and a second radio station of a radio communications system. This radio communications system also comprises a plurality of further radio stations as well as the first and the second radio station. The route passes via at least two of the further radio stations, so that information can be transmitted between the first and the second radio station over the route using radio. There is a radio device present which knows about adjacent relationships between radio stations of the radio communications system. In accordance with the invention the method includes the following steps:
(a) The radio device, in response to a request to determine the routing between the first and the second radio station, determines a part of the radio stations of the routing,
(b) the radio device sends to the first radio station and/or to the second radio station radio station identification information in each case relating to one or more radio stations of the part of the radio stations.

Information can be transmitted between the first and the second radio station via radio about the routing to be determined. This route runs via at least two of the further radio stations, which means that information which is to be transferred from the first to the second radio station or vice versa has to be received and forwarded at least twice by further radio stations. The radio stations via which the route runs are pairs of adjacent radio stations in each case, meaning that they can communicate with each other without forwarding information through other radio stations.

Radio station identification information relating to one or more of the further radio stations is transferred to the first and/or the second radio station. These further radio stations are a component of a routing between the first and the second radio station. They do not however form a complete route between these two radio stations, since the radio device only determines some of the radio stations of the routing. The radio stations, in relation to which radio station identification information is sent to the first and/or the second radio station can differ or can also be the same. Thus it is possible for all radio stations in respect of which the first radio station radio is sent station identification information to differ from those radio stations in respect of which the second radio station is sent station identification information. Another option is for radio station identification information to be sent both to the first and to the second radio station in respect of one or more radio stations. In an advantageous manner the first and/or the second radio station recognize on the basis of the message or messages which comprise the radio station identification information that the further radio stations indicated by the radio station identification information are radio stations of the routing to be determined.

The radio device which determines the part of the radio stations of the routing can for example be the base station of a cellular radio communications system. Furthermore the radio device can be implemented by a base station which executes the method steps described in conjunction with further network-side devices of a cellular radio communications system. The radio device can be a component of the radio communications system which includes the first, the second and the further radio stations, or can also be a component of another radio communications system. It is possible that at least one part of the radio stations of the radio communications system are both a component of the radio communications system which includes the radio stations and also of another radio communications system which includes the base station. Adjacent relationships between radio stations of the radio communications system are known to the radio device. These adjacent relationships can relate to all radio stations of the radio communications system or also to only a part of these radio stations, such as all currently active radio stations or radio stations interested in communication for example. The radio device can use its knowledge of the network topology to define parts of routings between the radio stations of the radio communications system.

A request to determine the routing can for example be directed to the radio device from the first or also from the second radio station. Thus it is possible for information about the routing partly determined by the radio device to only be transferred to the radio station making a request. Furthermore information about the part of the routing determined can also be transferred only to the destination radio station of the routing which has not made the request. Finally a transmission of information about the components of the routing determined by the radio device is also possible to both radio stations between which the route to be determined runs.

In a development of the invention a next method step (c) is provided in accordance with which, after the sending of the radio station identification information by a radio device, radio stations execute the determination of the remaining radio stations of the route between the first and the second radio station. The remaining radio stations are neither the first nor the second radio station nor radio stations in relation to which the first and/or the second radio station have been sent radio station identification information by the radio device. Whereas to determine the routing between the first and the second radio station the method steps (a) and (b) described above are thus performed by the radio device, this device is no longer involved in method step (c). Instead radio stations which complete the routing to be determined between the first and this second radio station are determined by radio stations, i.e. locally. The following devices in particular can be involved in executing the method for determining the remaining radio stations: the first radio station, the second radio station, the radio stations in relation to which the first and/or second radio station were sent radio station identification information, and also further radio stations such as the remaining radio stations which complete the routing to be determined.

In a development of the invention the radio device, to determine the radio stations of the part of the ratios stations of the routing, selects from a subset that it has defined these radio stations in respect of which the radio device knows about adjacent relationships. Thus not all radio stations of the radio communications system are available for election to the radio device when it determines the part of the radio stations of the route. This is expressed by the fact that, for each determination of a routing in accordance with the invention, such radio stations which are not a component of the subset are not determined as a part of the routing by the radio device and their radio station identification information is not sent to the radio stations. The subset used can however vary over time, especially if radio stations of the subset change their location or if other changes in the network topology occur. Information about the composition of the subset can be signaled by the radio device to all or to some radio stations.

In accordance with an embodiment of the invention the radio device sends the first radio station radio station identification information relating to the third radio station of the part of the radio stations and does not send the second radio station any radio station identification information relating to a radio station of the part of the radio stations. In this case precisely one radio station as part of the routing to be determined is named to the first radio station whereas no radio station is named to the second radio station as part of the routing.

Advantageously the first radio station, after receiving the radio station identification information relating to the third radio station, initiates a method for determining a routing between the first and third radio station. The third radio station initiates a method for determining a routing between a third and the second radio station. A method for determining a routing is taken below to mean a very wide diversity of methods which can deliver a routing between radio stations of the radio communications system. An example of the initiation of such a method by a radio station consists of the sending of a broadcast message by the radio station concerned which contains a call to determine the routing, with the method for determining the routing then executing by including other radio stations. A further example of the initiation of such a method by a radio station is checking whether the routing to be determined or at least parts of the routing to be determined are stored in a suitable memory to which the relevant radio station has access. In the case described the determination of the routing between the first and the third radio station is initiated by the first radio station and the determination of the routing between the third and the second radio station is initiated by the third radio station. The method for determining the routing between a third and the second radio station is advantageously initiated in this case after the complete or partial execution of the method for determining the routing between the first and third radio station.

In another embodiment of the invention, the first radio station, after receiving radio station identification information relating to a plurality of radio stations of the part of the radio stations, initiates a method for determining a routing between the first radio station and a radio station of the plurality of radio stations. Furthermore at least some of the radio stations of the plurality of radio stations each initiate a method for determining a routing, in which case one of the following three alternatives applies in each case: This is a routing between the relevant radio station of the plurality of radio stations and another radio station of the plurality of radio stations or it is a routing between the relevant radio station of the plurality of radio stations and the second radio station or it is a routing between the relevant radio station of the plurality of radio stations and a radio station of the part of the radio stations not included in the plurality of radio stations. In this embodiment a plurality of radio stations which are components of the routing to be determined are named to the first radio station. In this case it is both possible that the second radio station is not provided with the name of any radio stations of the routing to be determined or that also the second radio station has been sent radio station identification information of radio stations determined by the radio device. One possible arrangement is for example that the first radio station is provided with radio station identification information relating to a number of radio stations, with one of these radio stations matching the radio station of which the name has been given to the second radio station.

In an advantageous embodiment of the invention the radio device sends the first radio station identification information relating to a third radio station of the part of radio stations and sends the second radio station radio station identification information relating to a fourth radio station of the part of the radio stations. In this case both first and also the second radio station will be given the names of precisely one radio station determined by the radio device, in which case the third and the fourth radio station can match.

Advantageously, after receiving the radio station identification information relating to the third radio station, the first radio station initiates a method for determining a routing between the first and the third radio station, and the second radio station, after receiving radio station identification information relating to the fourth radio station, initiates a method for determining a routing between the second and the fourth radio station. In this case the complete routing is determined from both sides, which means starting both from the first and from the second radio station.

Advantageously the third radio station initiates a method for determining a routing between a third and the fourth radio station and/or the fourth radio station initiates a method for determining a routing between the fourth and the third radio station. The routing between the third and the fourth radio station can thus be determined either starting from a third or starting from a fourth or starting from both radio stations. In particular the initiation of the method for determining the routing between a third and the fourth radio station is undertaken after the execution or at least after part of the execution of the routing determination between the first and third and/or the second and the fourth radio station.

It is advantageous if the radio device station additionally sends to the first radio station radio station identification information relating to the fourth radio station and/or additionally sends to the second radio station radio station identification information relating to the third and the first radio stations. In this case for example the first radio station can forward to the third radio station the information that the fourth radio station is also a component of the complete routing to be determined.

The above-mentioned object in respect of the radio device is achieved by a radio device with the features of claim 11.

The radio device is suitable for a radio communications system, with the radio communications system, in addition to a first and a second radio station, including a plurality of further radio stations. In accordance with the invention the radio device features means for storing the adjacent relationships between radio stations of the radio communications system, and means for determining a part of the radio stations of a routing between the first and the second radio station in response to a request to determine a routing between the first and the second radio station, with the routing running via at least two of the further radio stations, so that information can be transmitted between the first and the second radio station via the routing using radio. Furthermore components of the inventive radio device are means to send one or more messages with radio station identification information relating to one all more radio stations of the part of the radio stations to the first radio station and/or with radio station identification information relating to one or more radio stations of the part of the radio stations to the second radio station.

The inventive radio device is especially suitable for execution of the method in accordance with one of the claims 1 to 10 described above. It can feature further suitable means for doing this.

The invention is explained in greater detail below with reference to an exemplary embodiment. The Figures show:

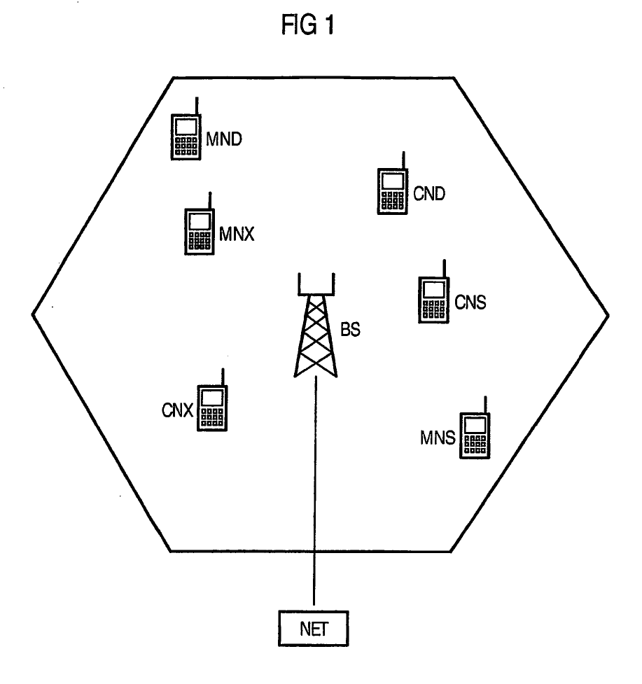

FIG. 1: a section of two radio communications systems,

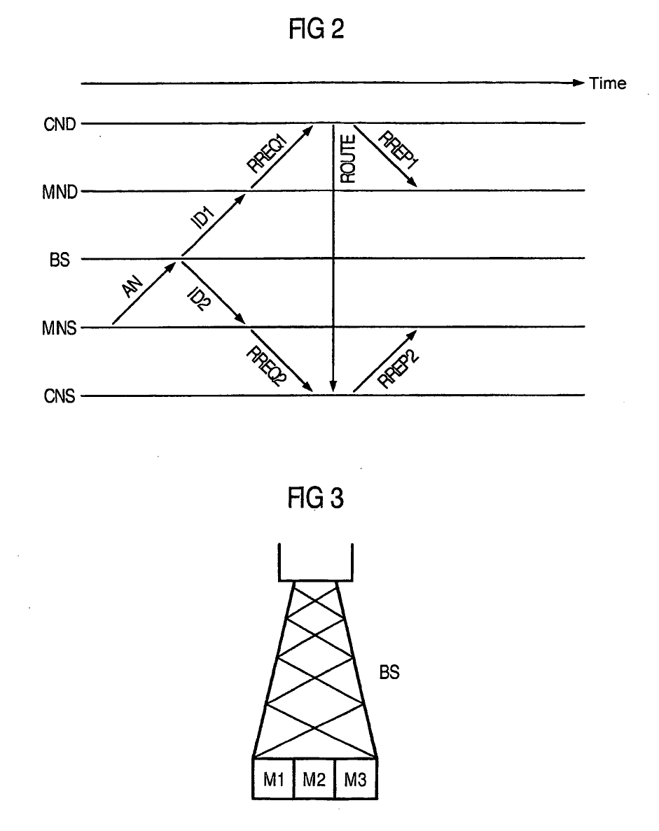

FIG. 2: a flowchart for an inventive method,

FIG. 3: a base station in accordance with invention.

FIG. 1 shows a radio communications system in the form of a WLAN, which comprises the mobile stations MNS, MNX, MND, CNS, CNX and CND. The mobile stations MNS, MNX, MND, CNS, CNX and CND are currently located in the radio cell of a base station BS of a cellular radio communications system, which can be embodied in accordance with the UMTS standard for example The base station BS is connected to further network-side devices NET of the cellular radio communications system, which in their turn can be connected to other communication and data networks. Further base stations of the cellular radio communications system and their relevant radio cells are not shown in the diagram for reasons of clarity.

In the WLAN the mobile stations MNS, MNX, MND, CNS, CNX and CND can communicate with each other directly in an ad-hoc mode without the information to be transmitted being forwarded by network-side devices of the WLAN for this purpose. Communication is between adjacent mobile stations in each case. Thus for example the mobile station MNS can communicate directly with the mobile station CNS whereas communication between the mobile station MNS and the mobile station CND can only take place if a routing is used, for example via the mobile station CNS, since the mobile station MNS is not located within the radio coverage area of the mobile station CND.

Although the mobile stations shown in FIG. 1 are mobile user stations, the method can also be employed in cases in which fixed radio stations are involved. Furthermore the radio stations of the WLAN can also be network-side radio stations such as for example radio access points or gateways to other communication systems.

The mobile stations MNS, MNX, MND, CNS, CNX and CND each have a suitable air interface for communication within the WLAN, of which one of the characteristic features is a specific send power. This transmit power results in the radio coverage area of the mobile stations MNS, MNX, MND, CNS, CNX and CND for communication within the WLAN being less than the radio cell of base station BS shown. Furthermore the mobile stations MNS, MND, CNS, CNX and CND have a suitable air interface for communication within the cellular radio communications system whereas the mobile station MNX does not have such an interface. The mobile stations MNS, MND, CNS, CNX and CND, which feature air interfaces which are suitable both for the WLAN and also for the cellular radio communications system, can thus be components of both communication systems. The air interface for the cellular radio communications system makes it possible for the mobile stations MNS, MND, CNS, CNX and CND to receive signals from the base station BS and to send signals to the base station BS. The transmission range associated with this air interface of the mobile stations MNS, MND, CNS, CNX and CND at least corresponds to the extent of the radio cell of the base station BS.

The case is considered below in which the mobile station MNS, the sender or the source, wishes to send data to the mobile station MND, the receiver or the destination. Within the cellular radio communications system this transmission would occur by the mobile station MNS sending the data to the base station BS which then forwards the data to the mobile station MND. The data is however not to be transferred via the cellular radio communications system but via the ad-hoc mode of the WLAN. In a similar way the case can also be considered in which the data is to be transferred via an ad-hoc mode of the cellular radio communications system in which no transmission of the data to network-side devices is undertaken.

Before the transmission of the data from the mobile station MNS to the mobile station MND a routing between the two mobile stations is determined. In accordance with the prior art this can be-implemented by the mobile stations MNS, MND, MNX, CNS, CND, CNX of the WLAN undertaking the determination on a decentral basis, i.e. without the involvement of the base station BS or other higher-ranking devices. To this end there are different methods for determination of a routing which as a rule involve the transmission of a plurality of broadcast signaling messages. Thus they impose an extensive strain on the generally scarce radio resources available.

As an alternative to this it is also possible for the base station BS to determine the routing between the mobile stations MNS and MND. To this end the mobile station MNS can submit a request for determining a routing to the base station BS. The base station BS then determines a routing and transfers the result to the mobile station MNS. To do this it is necessary for the base station to know the topology of the network, i.e. the adjacent relationships between the mobile stations MNS, MND, MNX, CNS, CND, CNX. This topology is notified to the base station BS by the mobile stations MNS, MND, MNX, CNS, CND, CNX. Different options exist for determining the topology of the network but these are not relevant to understanding the invention. It is assumed below that the adjacent relationships between the mobile stations MNS, MND, MNX, CNS, CND, CNX are known to the base station BS.

A method in which a base station determines the routing between two mobile stations is especially advantageous if all mobile stations of the WLAN have a suitable air interface for communicating with the base station BS. In the example considered however the mobile station MNX is missing such an interface.

A further problem in determining the routing in the base station lies in the fact that the computing effort involved in determining the routing in the base station increases sharply with the number of mobile stations within the relevant geographical area. This means that determining the routing through a network comprising a plurality of mobile stations involves too much effort for the base station.

To get around the difficulties mentioned, the base station BS defines a subset of the mobile stations MNS, MND, MNX, CNS, CND, CNX consisting of the mobile stations CNS, CND and CNX which forms what is referred to as a virtual core network (CN) within the mobile stations MNS, MND, MNX, CNS, CND, CNX of the WLAN. This means that the routing between two non-adjacent mobile stations MNS, MND, MNX, CNS, CND, CNX of the WLAN runs via at least one mobile station CNS, CND, CNX of the virtual core network.

The composition of the subset can be notified to mobile stations. In particular the mobile stations CNS, CND and CNX can be informed that they are components of the subset. Either each mobile station CNS, CND and CNX is merely told that it is a component of the subset or it is told which other mobile stations CNS, CND and CNX are components of the subset. Furthermore it is possible to inform of the other mobile stations MNS, MND and MNX about the composition of the subset. In this case information about all mobile stations CNS, CND and CNX of the subset all also about just a part of it, such as about the immediately adjacent mobile station of the subset, can be provided for example. Notifying mobile stations about the composition of the subset is not required for the method described below however.

The composition of the subset is determined by the base station BS depending on the topology of the network.

Thus the obvious choice for this is mobile stations in a central position for example, i.e. the geographical positions of mobile stations influence the composition of the subset. Further parameters which can be taken into consideration in determining the composition of the subset are hardware profiles and the mobility of mobile stations.

The number of mobile stations which form a subset depends among other things on the memory and computing capacity of the base station. The computing capacity is used if the base station executes the determination of a routing or of components of the routing. The memory capacity relates to the memory capacity for adjacent relationships between mobile stations.

FIG. 2 shows a flowchart of an inventive method. The timing of the method is shown to the right of the diagram. The arrows stand for messages which are sent between the relevant radio stations CNS, MNS, MND CND and the base station BS or for the sequence of specific sub-procedures.

At the beginning the mobile station MNS sends a request AN to the base station BS for determination of a routing to mobile station MND. The base station however does not then determine a complete routing between the mobile station MNS and the mobile station MND but instead selects two mobile stations from the mobile stations CNS, CND and CNX of the subset. Known algorithms for routing determination can be employed in the selection of the mobile stations from a subset.

Using the message ID1 the mobile station MND is notified about identification information of the mobile station CND and the mobile station MNS. The mobile station MNS is notified with the message ID2 about identification information of the mobile station CNS. The mobile stations MNS and MND use the relevant identification information to determine a routing to the mobile station CNS and CND of the subset specified to them. Different methodologies can be employed to do this, but these are not part of the invention. For example the mobile station MNS can have a routing stored for mobile station CNS or it initiates a method for determining the routing for mobile station CNS by sending out a broadcast message. It is essential that the mobile station MNS initiates or executes a method for determination of a routing for mobile station CNS while mobile station MND initiates or executes a method for determination of a routing for mobile station CND.

In FIG. 2 the mobile station MNS sends a broadcast message RREQ2 to its adjacent mobile stations comprising a request for determination of a routing, identification information of the mobile station MNS and of the mobile station CNS, as well as identification information of the routing search. A correspondingly structured message RREQ1 with identification information of the mobile station MND and the mobile station CND is also sent by the mobile station MND.

With the message RREQ1 the mobile station MND also transfers information indicating that the complete route to mobile station CND is to run via mobile station CNS. This information can be taken by the mobile station MND from the message ID1. Alternatively in message ID1 reference can also be made to the identification information of the routing search of mobile station MNS which is sent with the message RREQ2. After the receipt of the information about the further route of the routing through the mobile station CND a routing is determined between the mobile stations CND and CNS, shown schematically in FIG. 2 by ROUTE. Again different methods, e.g. methods known from ad-hoc systems, can be used for routing determination. The method used for routing determination within the subset of the mobile stations CND, CNS and CNX can differ from the method used by the other mobile stations MNS, MND and MNX. This is especially the case if the mobile stations MNS, MND and MNX of the subset have information available to them about routings within the subset. If for example the mobile station CND knows a routing to mobile station CNS, it can send a unicast message to the latter, by which the mobile station CNS is informed that data is to be forwarded from the mobile station MNS to the mobile station MND via the mobile station CND.

Advantageously the routing between two mobile stations of the subset is routed exclusively via mobile stations of the subset. It is however also possible for there to be no restrictions in this respect.

The mobile station CNS is adjacent to mobile station MNS, so that, after receiving the signal RREQ2 and after determining the routing between the mobile stations CNS and CND, it sends a response signal RREP2 to the mobile station MNS, which contains the requested routing between the mobile station MNS and the mobile station CNS. The mobile station MND by contrast is not adjacent to mobile station CND, so that the path between the mobile stations MND and CND is routed via the mobile station MNX. After a corresponding signal has been forwarded from the mobile station CND, the mobile station CND, after determining the routings between the mobile stations CNS and CND, sends a response message RREP1 back to the mobile station MND which informs it that the routing sought between the mobile stations MND and CND is routed via the mobile station MNX.

After the steps shown in FIG. 2 have been performed, data can be transferred from the mobile station MNS to mobile station MND. To this end the mobile station MNS knows the routing up to the subset of the mobile stations, i.e. up to mobile station CNS. Information about the further routing of the routing within a subset up to the mobile station MND is not available to the mobile station MNS. Likewise the mobile station MND only has information about the routing to the mobile station CND available to it. The mobile station MNS and then sends the data about the routing determined from the mobile stations as far as mobile station CNS which forwards the data about the routing determined from the mobile stations within the subset of the mobile stations to the mobile station CND, from where the data about the routing determined from the mobile stations between the mobile stations CND and MND arrives at the mobile station MND. In a similar way data or control information can be transferred from the mobile station MND to the mobile station MNS.

Using the method described, the routing is partly determined by the base station and partly determined by the mobile stations. The base station in this case defines mobile stations which are a component of the routing sought, without however determining the complete routing. The mobile stations CNS and CND determined by the base station BS represent fixed points via which the routing must be routed. After these fixed points have been determined or after a suitable notification about the fixed points has been received the mobile stations complete the routing without support from the base station, so that data is able to be transmitted over the complete routing. By scaling at the size of the subset of mobile stations the base station can define the extent to which the operating effort for determining the routing lies in the base station or in the mobile stations. Furthermore the base station can also influence the quality of a routing by selecting as a result of its knowledge of the topology especially suitable mobile stations of the subset.

A further advantage of the described method is that mobile stations which do not have a suitable interface for communicating with the base station, as is the case with the mobile station MNX, can participate in the method for determining the routing and can be a component of the routing.

It is also advantageous that routing determination by a mobile station which is not a component of the subset of mobile stations to a mobile station of the subset as rule requires less time or signaling overhead than in the reverse case. The reason for this is that often part routings of the routing from a mobile station which is not part of the subset of mobile stations to a mobile station of the subset are known in mobile stations of this part routing. In the reverse case by contrast, namely that part routings of the routing from a mobile station which is a component of the subset of mobile stations to a mobile station which is not a component of the subset of mobile stations are known, occurs less frequently.

There are numerous possibilities for variation of the method described. Thus it is possible for the mobile station MNS and/or the mobile station MND to be given the names of a plurality of mobile stations of the subset. For example the mobile station MNS could be sent identification information of the two mobile stations CNS and CND by the base station BS. Furthermore identification information can also be sent to mobile stations other than the mobile stations MNS and MND. Thus the base station BS could send the mobile station MNS identification information of the mobile station CNS, the mobile station CNS identification information of the mobile station CND and the mobile station CND identification information of the mobile station MND.

The different embodiments share the feature that in each case the base station BS does not determine a complete routing between the mobile stations MNS and MND but only components of the routing in the form of one or more mobile stations. Identification information of the mobile stations determined in this way is then sent to suitable mobile stations. Then a number of methods are executed for determining a part routings which are executed locally by the mobile stations without further aid from the base station BS.

FIG. 3 shows an inventive base station BS with means M1 for storing adjacent relationships. In this way the topology of the entire network or of just part of the network of the mobile stations can be stored. The means M2 are used to determine a part of the radio stations of the routing to be determined in response to a request. Finally the means M3 are present for sending one or more messages with identification information relating to one or more mobile stations of the part of the specified mobile stations to the mobile station which forms the start point of the routing, and/or with identification information relating to one or more mobile stations of the part of the specified mobile stations to the mobile station which forms the end point of the routing.

Whereas in FIG. 3 the means M1, M2 and M3 are accommodated in the base station BS, it is the same if one or more of the means are present in one or more of the devices connected to the base station BS. Accordingly the methods steps described above can be executed both by the base station BS and also by the base station BS in collaboration with suitable devices connected to it.

1-11. (canceled)

12. A method for determining a route for a radio transmission between a first radio station and a second radio station in a radio communications system having the first radio station, the second radio station, a plurality of potential carrier radio stations and a radio device, comprising:
sending a request to determine a route between the first and second radio stations;
using the adjacent positioning relationships at the radio device to identify at least one carrier radio station to route the radio transmission, the at least one carrier radio station being identified in response to the request to determine a route;
sending identification information from the radio device to the first radio station and/or the second radio station to identify the at least one carrier radio station; and
after the identification information has been sent, identifying at least one additional carrier radio station at the radio stations of the radio communications system; and
routing the radio transmission between the first radio station and the second radio station using the carrier radio stations identified by the radio device and the radio stations.

13. The method in accordance with claim 12, wherein
the radio device, to identify at least one carrier radio station, selects the at least one carrier radio station from a plurality of radio stations for which the radio device has adjacent positioning relationships.

14. The method in accordance with claim 12, wherein
the radio device sends the first radio station identification information to identify a third radio station as the at least one carrier radio station, and
the radio device does not send the second radio station any identification information.

15. The method in accordance with claim 14, wherein
the first radio station, after receiving the identification information relating to the third radio station, initializes the determination of a route between the first radio station and the third radio station, and
the third radio station between the third radio station and the second radio station.

16. The method in accordance with claim 12, wherein
the radio device identifies a plurality of carrier radio stations,
the first radio station after receiving identification information relating to the plurality of carrier radio stations, initializes the determination of a route between the first radio station and one of the plurality of carrier radio stations, and
at least one of the carrier radio stations identified by the radio device initializes the determination of a route:
between the relevant carrier radio station and another carrier radio station identified by the radio device, or
between the relevant carrier radio station and the second radio station.

17. The method in accordance with claim 12, wherein
the radio device identifies at least a third radio station and a fourth radio station as carrier radio stations,
the radio device sends the first radio station identification information to identify the third radio station, and
the radio device sends the second radio station identification information to identify the fourth radio station.

18. The method in accordance with claim 17, wherein
the first radio station, after receiving the identification information identifying the third radio station, initializes the determination of a route between the first radio station and the third radio station, and
the second radio station, after receiving the identification information identifying the fourth radio station, initializes the determination of a route between the second radio station and the fourth radio station.

19. The method in accordance with 17, wherein
the third radio station initializes the determination of a route between the third radio station and the fourth radio station and/or
the fourth radio station initializes the determination of a route between the fourth radio station and the third radio station.

20. The method in accordance with claim 17, wherein
the radio device additionally sends the first radio station identification information identifying the fourth radio station and/or additionally sends the second radio station identification information identifying the third radio station and the first radio station.

21. The method in accordance with claim 13, wherein
the radio device sends the first radio station identification information to identify a third radio station as the at least one carrier radio station, and
the radio device does not send the second radio station any identification information.

22. The method in accordance with claim 21, wherein
the first radio station, after receiving the identification information relating to the third radio station, initializes the determination of a route between the first radio station and the third radio station, and
the third radio station initializes the determination of a route between the third radio station and the second radio station.

23. The method in accordance with claim 13, wherein
the radio device identifies a plurality of carrier radio stations,
the first radio station after receiving identification information relating to the plurality of carrier radio stations, initializes the determination of a route between the first radio station and one of the plurality of carrier radio stations, and
at least one of the carrier radio stations identified by the radio device initializes the determination of a route:
between the relevant carrier radio station and another carrier radio station identified by the radio device, or
between the relevant carrier radio station and the second radio station.

24. The method in accordance with claim 13, wherein
the radio device identifies at least a third radio station and a fourth radio station as carrier radio stations,
the radio device sends the first radio station identification information to identify the third radio station, and
the radio device sends the second radio station identification information to identify the fourth radio station.

25. The method in accordance with claim 24, wherein
the first radio station, after receiving the identification information identifying the third radio station, initializes the determination of a route between the first radio station and the third radio station, and
the second radio station, after receiving the identification information identifying the fourth radio station, initializes the determination of a route between the second radio station and the fourth radio station.

26. The method in accordance with 25, wherein
the third radio station initializes the determination of a route between the third radio station and the fourth radio station and/or
the fourth radio station initializes the determination of a route between the fourth radio station and the third radio station.

27. The method in accordance with claim 26, wherein
the radio device additionally sends the first radio station identification information identifying the fourth radio station and/or additionally sends the second radio station identification information identifying the third radio station and the first radio station.

28. A radio device for a radio communication system having a first radio station, a second radio station, and a plurality of potential carrier radio stations, comprising:
a memory to store adjacent positioning relationships between the radio stations of the radio communications system;
a unit to use the adjacent positioning relationships to identify at least one carrier radio station to route a radio transmission on a path between the first radio station and the second radio station, the at least one carrier radio station being identified in response to a request for routing; and
a transmitter to send identification information identifying the at least one carrier radio station, the identification information being transmitted to the first radio station and/or the second radio station so that after the identification information is sent, the radio stations will determine at least one additional carrier radio station to complete the path between the first radio station and the second radio station.
